(19) United States
(12) Patent Application Publication
(10) Pub. No.: US 2025/0027906 A1
(43) Pub. Date: Jan. 23, 2025

(54) REPLACEABLE ONE-PIECE CENTERING ASSEMBLY FOR EDDY CURRENT PROBE

(71) Applicant: Zetec, Inc., Snoqualmie, WA (US)

(72) Inventors: William Frederick Ziegenhagen, Black Diamond, WA (US); Paubla M. Tarango, Renton, WA (US); Stephen Timm, Bellevue, WA (US); Wayne Rector, Bellevue, WA (US)

(21) Appl. No.: 18/775,620

(22) Filed: Jul. 17, 2024

Related U.S. Application Data
(60) Provisional application No. 63/514,084, filed on Jul. 17, 2023.

(51) Int. Cl. G01N 27/9013; G01N 27/90

(52) U.S. Cl. CPC G01N 27/902; G01N 27/9006

(57) ABSTRACT

A centering assembly for an eddy current probe having a shaft comprises a one-piece centering assembly comprising a first half and a second half joined by a hinge. Each of the first half and the second half comprise a plurality of cantilevered legs projecting radially about a central aperture. The centering assembly further includes at least one securement mechanism for securing the one-piece centering assembly about the shaft.

### CROSS-REFERENCE TO RELATED APPLICATION

This application claims priority under 35 U.S.C. § 119, based on U.S. Provisional Patent Application No. 63/514,084 filed Jul. 17, 2023, titled “Replaceable One-Piece Centering Assembly for Eddy Current Probe,” the disclosure of which is hereby incorporated by reference.

### BACKGROUND

Steam generation for driving turbines has been an aspect of electrical power generation, for many decades. Routine monitoring of the condition of high-pressure steam tubes in steam generators is critical. Steam tube inspection is generally conducted with cylindrically shaped eddy current probes that are inserted into steam tube arrays and travel through the arrays/tubes attached to cabling while monitoring equipment records the eddy current response as the probe travels through the tubes.

Eddy current probes operate by coils alternating an electromagnet field onto a conduit as it travels within the conduit and receiving electromagnetic returns from the conduit. The electromagnetic field produces eddy currents in the tubes, which can be measured either by a change in impedance of the excitation coil or by separate coils, hall-effect sensors or magneto-resistive sensors. In interacting with the conduit structure, the field is able to locate defects by recognizing anomalies, such as disbonds, bubbles, cracks, corrosion, delaminations, thickness variation, and the like.

Common problems affecting the ability to detect tube wear and flaws with eddy current probes include wobble of the probe while travelling through the tube and maintaining the probe evenly centered within the tube so that it is not too close to any one section of the tube wall.

Typical eddy current probes for non-destructive testing of heat exchanger tubing and the like are composed of a probe head supporting a plurality of sensing coils, a flexible plastic conduit with wiring and a connector providing a removable connection to testing equipment. Probe heads often incorporate features to center the coil assembly in the center of the tube under inspection. This centering reduces “lift-off” in which the probe moves away from the tube wall and such centering is important for maintaining good signal quality.

This centering function has been done in the prior art by machined plastic, metallic, or ceramic parts that incorporate a plurality of flexible fingers extending from the probe that apply an equal circumferential force to the inner wall of the tubing under inspection. Because these parts bear against the tube wall, they are subject to wear as the sensor is moved in and out of hundreds of tubes which may involve thousands of feet of sliding friction wear. These effects can drive the sensor out of its centered position causing lift-off errors. Additionally, if the wear on the feet is even but substantial, the feet may no longer press against the tube wall and the sensor may become loose within the tube, which causes erratic movement and creates data quality issues. Accordingly, after a period of use the probe becomes unreliable and therefore unusable due to the abraded centering feet.

### BRIEF DESCRIPTION OF THE DRAWINGS

FIGS. 1A and 1B are right and left perspective views, respectively, of an eddy current probe in a partially assembled configuration consistent with embodiments described herein;

FIGS. 1C and 1D are right and left perspective views, respectively, of an eddy current probe in an assembled configuration consistent with embodiments described herein;

FIGS. 2A and 2B are front and rear isometric views, respectively, of a centering assembly consistent with an embodiment described herein;

FIG. 2C is an end view of the centering assembly of FIGS. 2A and 2B consistent with an embodiment described herein; and

FIG. 2D is a cross-sectional view of the centering assembly of FIGS. 2A-2C, consistent with an embodiment described herein, taken along the line A-A in FIG. 2C.

### DETAILED DESCRIPTION

The following detailed description refers to the accompanying drawings. The same reference numbers in different drawings may identify the same or similar elements. Also, the following detailed description does not limit the invention.

Implementations described herein relate to non-destructive testing devices that include one or more testing coils for introducing an electromagnetic field into a tubular conduit under test. The non-destructive testing devices include a probe body coupled to a shaft via one or more centering assemblies (also referred to as centering feet). The centering assemblies include one or more resilient portions configured to be radially biased away from the shaft. The resilient portions are configured to engage the internal surface of the conduit under test to keep the probe body centered within the conduit as the probe body travels within the conduit.

Consistent with implementations described herein, the one or more centering assemblies may include resilient portions that include one-piece replaceable components that are removably coupled to the probe shaft. In particular, each one-piece centering assembly may include half assemblies joined about a hinge portion.

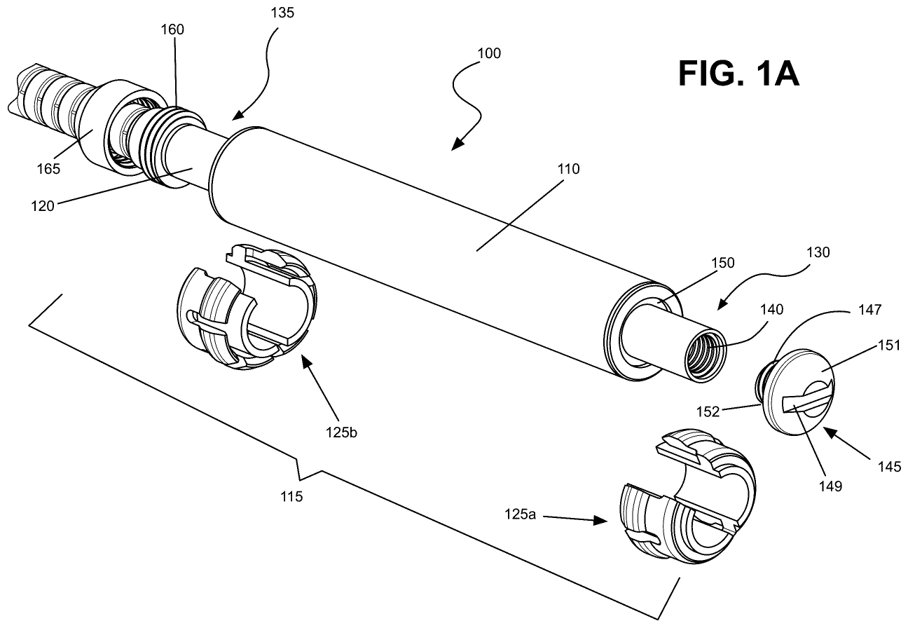

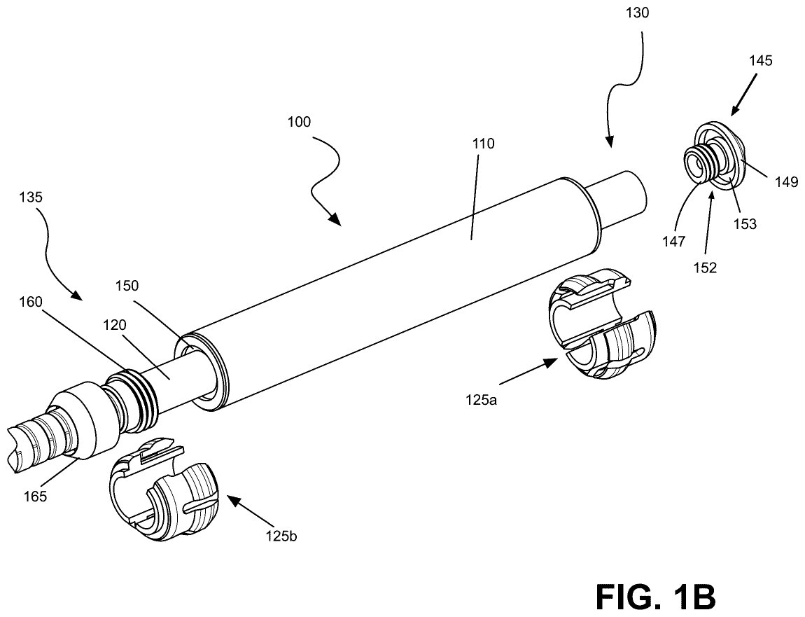

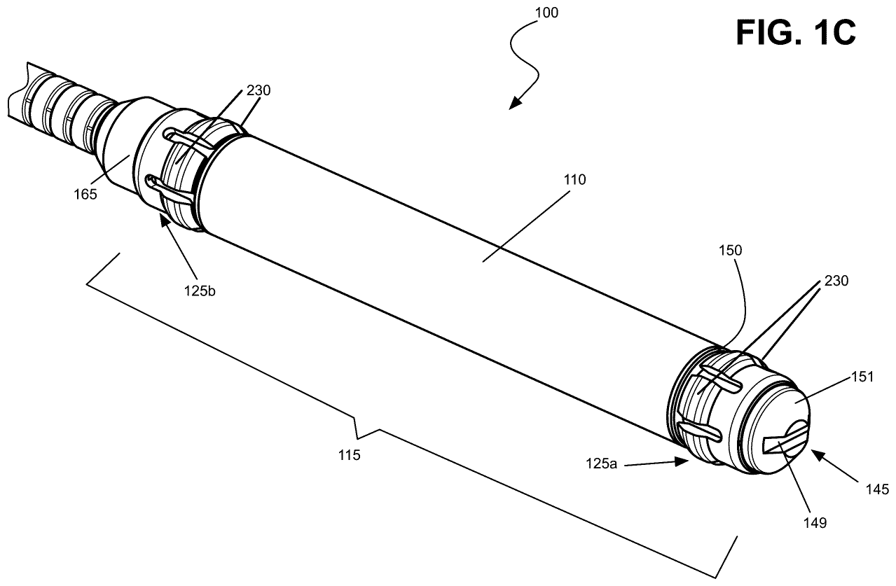

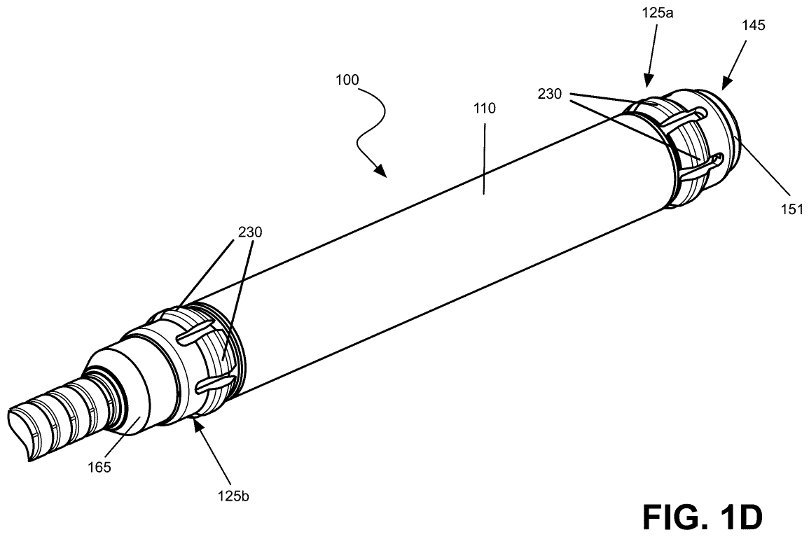

FIGS. 1A and 1B illustrate right and left perspective views, respectively, of an eddy current probe 100 in an exploded or partially assembled configuration. FIGS. 1C and 1D illustrate right and left perspective views, respectively, of an eddy current probe 100 in an assembled configuration. As shown, eddy current probe 100 includes a probe body 110 and a probe-centering apparatus 115. Probe body 110 includes at least one eddy current coil that projects and detects an alternating electromagnetic field within a tube under test. Consistent with implementations described herein, probe centering apparatus 115 includes a tubular shaft 120 and a pair of replaceable centering assemblies 125 for centering probe body 110 within a tube under test (not shown).

As shown in FIGS. 1A-1D, probe body 110 is coupled to shaft 120 between a forward centering assembly 125a and a rearward centering assembly 125b (referred to collectively as centering assemblies 125 and individually as centering assembly 125). As described herein, centering assemblies 125 are configured to maintain probe body 110 centered within a tube under test during testing.

As further shown in FIGS. 1A-1D, tubular shaft 120 includes a forward portion 130 which extends forwardly from probe body 110 and a rearward portion 135 which extends rearwardly from probe body 110. Forward portion 130 of shaft 120 includes an internally threaded portion 140 for receiving a cap screw 145, which secures forward centering assembly 125a to shaft 120, as described below. Rearward portion 135 of shaft 120 includes an externally threaded portion for engaging a collar 165, which secures rearward centering assembly 125b to shaft 120, as described below.

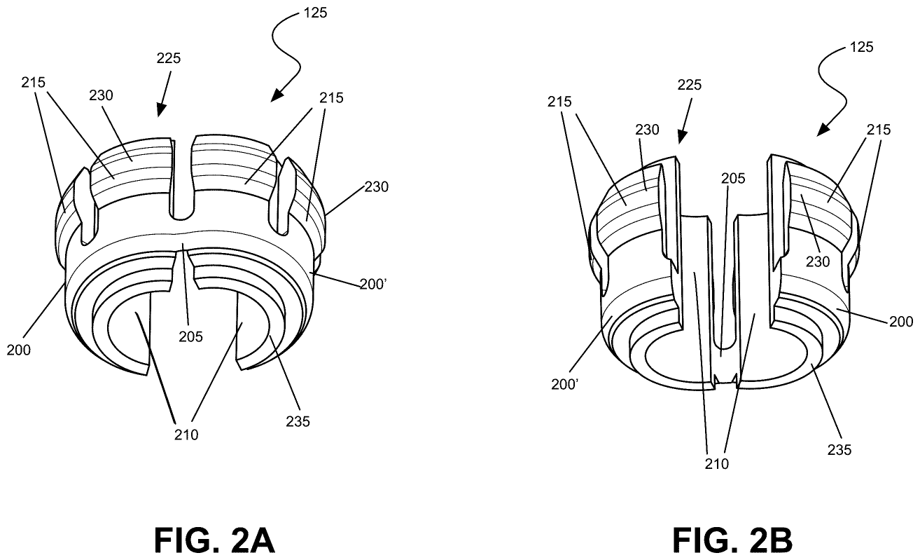

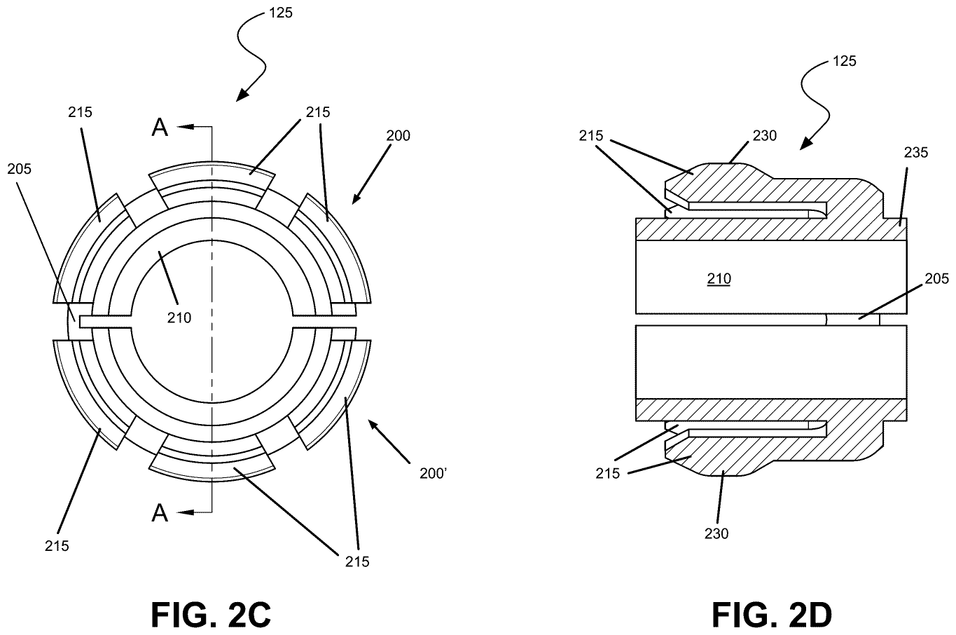

FIG. 2A is a front isometric view of centering assembly 125 and FIG. 2B is a rear isometric view of centering assembly 125. FIG. 2C is an end view of centering assembly 125 consistent with an embodiment described herein; and FIG. 2D is a cross-sectional view of the centering assembly 125, consistent with an embodiment described herein, taken along the line A-A in FIG. 2C. As shown in FIGS. 2A-2D, consistent with an implementation described herein, each centering assembly 125 is formed from as a single piece from a suitable resilient material, such as a plastic or polymer, and is formed as two half components 200/200′ joined by a hinge portion 205. Each half component 200 includes a semicircular tubular base portion 210, from which a plurality of resilient, circumferentially spaced, cantilevered legs 215 project radially and distally outwardly therefrom and are coaxially spaced apart from base portion 210. As shown in FIGS. 1C and 1D, upon assembly, when each half component 200/200′ is joined about shaft 120, tubular base portions 210 form a central aperture 220 configured to engage shaft 120.

Each cantilevered leg 215 includes a centering foot 225 at its distal end (relative to tubular base portion 210) that includes a curvilinear outer surface 230, at least a portion of which is configured to extend beyond a body of an eddy current probe to which centering assembly 100 is attached (not shown). As shown in FIGS. 1C and 1D, curvilinear outer surface 230 of each centering foot 225 thus forms the outer diameter of each centering assembly 125. Centering feet 225 on respective legs 215 extend outwardly from the base portion 210 and probe shaft 120, such that the circumferentially spaced centering feet 225, and not the eddy current probe body 110, slidably engage the tube under test through which the probe travels. As shown, in one implementation, the proximal end of each of resilient cantilevered legs 215 projects from one end of tubular base portion 210, so that the distal end of each leg 215 is able to flex toward base portion 210. Consistent with implementations described herein, an outside diameter of centering assembly 125 (i.e., the distance between outermost portions of opposing outer surfaces 230) may be slightly larger than an inside diameter of a tube under test. The resilient and circumferentially spaced nature of cantilevered legs 215 allows each leg to flex as necessary to maintain the probe centered within the tube when the legs 215 engage the inner surface of the tube. In one implementation, each centering assembly 125 includes six cantilevered legs 215, although any suitable number of legs 215 may be used.

As shown in FIGS. 2A-2D, centering assembly 125 comprises two matching halves (identified as 200 and 200′) dividing the base portion 210 into equal half cylinders that are removably secured around the shaft. Consistent with implementations described herein, halves 200 and 200′ are manufactured (e.g., injection molded, 3D printed, etc.) as a single piece joined by hinge portion 205. As shown in FIGS. 2A and 2B, hinge portion 205 is configured to include thinner or more resilient dimensions, thus allowing half 200 to flex relative to half 200′, or vice versa. This arrangement may also be referred to as a living hinge. In this way, halves 200/200′ may be opened for receiving shaft 120 and then closed about shaft 120 when in position relative to probe body 110.

To facilitate securing of centering assemblies 125 to shaft 120, tubular base portion 210 may be configured to extend beyond a proximal end of legs 215 so as to form a cylindrical lip 235 when halves 200 and 200′ are coupled about shaft 120. Cap screw 145 includes a threaded portion 147 and a cap portion 149. Threaded portion 147 is configured to engage internal threads 140 in shaft 120. Cap portion 149 includes an external side 151 and an internal side 152. External side 151 includes a tool engagement feature, such as a screw head (e.g., slotted, Phillips, Torx, etc.), a hexagonal shape, etc. for engaging a tool. Internal side 152 includes an annular groove 153, as shown in FIG. 1B, for engaging lip 235 in forward centering assembly 125. As shown in FIGS. 1A-2B, during assembly, cap screw 145 is threaded onto shaft 120 and the annular groove 153 on internal side 152 of cap portion 149 engages lip 235 to secure forward centering assembly 125a to shaft 120.

Consistent with some implementations, probe body 110 may also be configured to facilitate securing of centering assemblies 125 to shaft 120. In particular, as shown in FIGS. 1A and 1B, outside ends of probe body 110 may include an annular groove 150 therein adjacent to shaft 120. Annular groove 150 may be sized to accommodate the dimensions of base portion 210, such that, upon assembly, distal ends of tubular base portion 210 are received within groove 150, thus retaining the distal portion of halves 200 and 200′ coupled about shaft 120.

Regarding rearward centering assembly 125b, lip 235 is configured to abut externally threaded portion 160 when rearward centering assembly 125b is engaged about shaft 120. Upon assembly, collar 165 as threaded onto threaded portion 160 which causes lip 235 to be captured within a leading edge of collar 165. The opposing end of tubular base portion 210 of rearward centering assembly 125b is captured with the groove 150 (not shown) on the rearward end of probe body 110.

To replace centering assemblies 125 as they become abraded through use, an end user may remove cap screw 145 and/or retract collar 165. Halves 200 and/or 200′ may be hinged apart at hinge 205 and removed from shaft 120. New centering assemblies 125 may be fitted about shaft 120 and secured via cap screw 145/collar 165 in the manner described above.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. A centering assembly for an eddy current probe having a shaft, comprising:
a one-piece centering assembly comprising a first half and a second half joined by a hinge,
wherein each of the first half and the second half comprise a plurality of cantilevered legs projecting radially about a central aperture; and
at least one securement mechanism for securing the one-piece centering assembly about the shaft.

2. The centering assembly of claim 1, wherein the one-piece centering assembly is formed of a resilient material.

3. The centering assembly of claim 1, wherein the first half and the second half are joined by an integrated hinge portion.

4. The centering assembly of claim 3, wherein the integrated hinge portion comprises a living hinge.

5. The centering assembly of claim 1,
wherein the a one-piece centering assembly comprises a tubular base portion, and
wherein the first half of the one-piece centering assembly comprises a first half of the tubular base portion and the second half of the one-piece centering assembly comprises a second half of the tubular base portion.

6. The centering assembly of claim 5, wherein upon assembly, the first half of the tubular base portion and the second half of the tubular base portion engage form a tube to engage the shaft of the eddy current probe.

7. The centering assembly of claim 5, wherein a proximal end of each of the plurality of cantilevered legs projects from one end of the tubular base portion and a distal end of each of the plurality of cantilevered legs is permitted to flex relative to the tubular base portion.

8. The centering assembly of claim 1, wherein the plurality of cantilevered legs comprising six circumferentially spaced apart cantilevered legs.

9. The centering assembly of claim 1, wherein each of the plurality of cantilevered legs comprises a curvilinear outer surface that forms an outside diameter of the one-piece centering assembly when assembled onto the shaft.

10. The centering assembly of claim 1, wherein the at least one securement mechanism comprises a cap screw that engages an end of the shaft,
wherein the cap screw further engages an end of the one-piece centering assembly to secure the one-piece centering assembly to the shaft.

11. A tube testing probe assembly, comprising:
an eddy current probe having a tubular probe shaft;
a first centering assembly secured to a distal end of the probe shaft; and
a second centering assembly secured to a proximal end of the probe shaft,
wherein at least one of the first and second centering assemblies comprises:
a one-piece centering assembly comprising a first half and a second half joined by a hinge,
wherein each of the first half and the second half comprise a plurality of cantilevered legs projecting radially about a central aperture.

12. The tube testing probe assembly of claim 11, wherein the one-piece centering assembly is formed of a resilient material.

13. The tube testing probe assembly of claim 11, wherein the first half and the second half are joined by an integrated living hinge portion.

14. The tube testing probe assembly of claim 11, wherein at least one of the first and second centering assemblies are removeable and replaceable by an end user.

15. The tube testing probe assembly of claim 11,
wherein each one-piece centering assembly comprises a tubular base portion,
wherein the first half of each one-piece centering assembly comprises a first half of the tubular base portion and the second half of the one-piece centering assembly comprises a second half of the tubular base portion, and
wherein upon assembly, the first half of the tubular base portion and the second half of the tubular base portion engage form a tube to engage the probe shaft.

16. The tube testing probe assembly of claim 15, wherein a proximal end of each of the plurality of cantilevered legs projects from one end of the tubular base portion and a distal end of each of the plurality of cantilevered legs is permitted to flex relative to the tubular base portion.

17. The tube testing probe assembly of claim 11, wherein the plurality of cantilevered legs comprising six circumferentially spaced apart cantilevered legs.

18. The tube testing probe assembly of claim 11, wherein each of the plurality of cantilevered legs comprises a curvilinear outer surface that forms an outside diameter of the one-piece centering assembly when assembled onto the probe shaft.

19. The tube testing probe assembly of claim 11, wherein both of the first and second centering assemblies comprise removeable and replaceable one-piece centering assemblies.

20. The tube testing probe assembly of claim 11, further comprising:
at least one securement mechanism for securing the one-piece centering assembly about the probe shaft,
wherein the at least one securement mechanism comprises one of: a cap screw or a collar configured to engage an end of the one-piece centering assembly to secure the one-piece centering assembly to the probe shaft.
